(19) United States
(12) Patent Application Publication
(10) Pub. No.: US 2024/0326805 A1
(43) Pub. Date: Oct. 3, 2024

(54) VEHICLE CONTROL DEVICE AND CONTROL METHOD

(71) Applicant: HONDA MOTOR CO., LTD., Tokyo (JP)

(72) Inventor: Shota ISHIKAWA, Tokyo (JP)

(73) Assignee: HONDA MOTOR CO., LTD., Tokyo (JP)

(21) Appl. No.: 18/581,414

(22) Filed: Feb. 20, 2024

(30) Foreign Application Priority Data
Mar. 28, 2023 (JP) 2023-052087

(51) Int. Cl. B60W 30/14

(52) U.S. Cl. CPC B60W 30/146; B60W 2552/53; B60W 2554/4041; B60W 2554/4045

(57) ABSTRACT

A method includes: recognizing a surrounding situation of a vehicle; determining whether there is a crosswalk in a scheduled traveling lane of the vehicle that is traveling or starts traveling, based on a recognition of the surrounding situation; determining whether there is an adjacent lane that is adjacent to the scheduled traveling lane and has the same traveling direction as the scheduled traveling lane, based on the recognition of the surrounding situation or map information prepared in advance; determining, when it is determined that there is the crosswalk and there is the adjacent lane, whether there is another vehicle that is on the adjacent lane and is stopped in front of the crosswalk when viewed from the vehicle, based on the recognition of the surrounding situation; and performing restraint control for restraining a travel speed of the vehicle when it is determined that there is the another vehicle.

### CROSS-REFERENCE RELATED APPLICATIONS

This application is based on and claims priority under 35 USC 119 from Japanese Patent Application No. 2023-052087 filed on Mar. 28, 2023, the contents of which are incorporated herein by reference.

### TECHNICAL FIELD

The present disclosure relates to a vehicle control device and a control method.

### BACKGROUND

In recent years, improvement in traffic safety has been required in order to enable inclusion, safety, toughness, and sustainability of urban and human residents.

From a viewpoint of improving traffic safety, development of a driving support technique and an autonomous driving technique for a moving body (for example, a vehicle) has been advanced (for example, see Japanese Patent Application Laid-Open Publication No. 2012-238185 and Japanese Patent Application Laid-Open Publication No. 2016-053755).

However, in the related art, there is room for improvement from the viewpoint of improving traffic safety.

The present disclosure provides a vehicle control device and a control method capable of improving traffic safety. This further improves the traffic safety and contributes to the development of a sustainable transportation system.

### SUMMARY

A first aspect of the present disclosure relates to a vehicle control device that controls a vehicle, the vehicle control device including:
a recognition circuit configured to recognize a surrounding situation of the vehicle;
a first determination circuit configured to determine whether there is a crosswalk in a scheduled traveling lane of the vehicle that is traveling or starts traveling, based on a recognition result of the recognition circuit;
a second determination circuit configured to determine whether there is an adjacent lane that is adjacent to the scheduled traveling lane and has the same traveling direction as the scheduled traveling lane, based on the recognition result of the recognition circuit or map information prepared in advance;
a third determination circuit configured to, when the first determination circuit determines that there is the crosswalk and the second determination circuit determines that there is the adjacent lane, determine, based on the recognition result of the recognition circuit, whether there is another vehicle that is on the adjacent lane and is stopped in front of the crosswalk when viewed from the vehicle; and
a travel controller configured to perform restraint control for restraining a travel speed of the vehicle when the third determination circuit determines that there is the another vehicle.

A second aspect of the present disclosure relates to a control method performed by a computer that controls a vehicle, the control method including:
recognizing a surrounding situation of the vehicle;
determining whether there is a crosswalk in a scheduled traveling lane of the vehicle that is traveling or starts traveling, based on a recognition result of the surrounding situation;
determining whether there is an adjacent lane that is adjacent to the scheduled traveling lane and has the same traveling direction as the scheduled traveling lane, based on the recognition result of the surrounding situation or map information prepared in advance;
determining, when it is determined that there is the crosswalk and there is the adjacent lane, whether there is another vehicle that is on the adjacent lane and is stopped in front of the crosswalk when viewed from the vehicle, based on the recognition result of the surrounding situation; and
performing restraint control for restraining a travel speed of the vehicle when it is determined that there is the another vehicle.

### BRIEF DESCRIPTION OF DRAWINGS

Exemplary embodiment of the present disclosure will be described in detail based on the following figures, wherein:

FIG. 1 is a block diagram showing an overall configuration of a vehicle system 1 including a control device 100;

FIG. 2 is a diagram (part 1) showing a specific example of control by a control device 100;

FIG. 3 is a diagram (part 2) showing a specific example of the control by the control device 100;

FIG. 4 is a diagram (part 3) showing a specific example of the control by the control device 100;

FIG. 5 is a diagram (part 4) showing a specific example of the control by the control device 100; and

FIG. 6 is a flowchart showing an example of processing performed by the control device 100.

### DESCRIPTION OF EMBODIMENTS

Hereinafter, an embodiment of a vehicle control device and a control method of the present disclosure will be described with reference to the drawings. The drawings are viewed in directions of reference numerals. The following embodiment does not limit the disclosure described in claims, and all combinations of features described in the embodiment are not necessarily essential to the disclosure. Two or more of a plurality of features described in the embodiment may be combined freely.

In addition, in the following description, the same or similar elements are denoted by the same or similar reference numerals, and the description thereof may be omitted or simplified as appropriate.

### <Overall Configuration of Vehicle System 1>

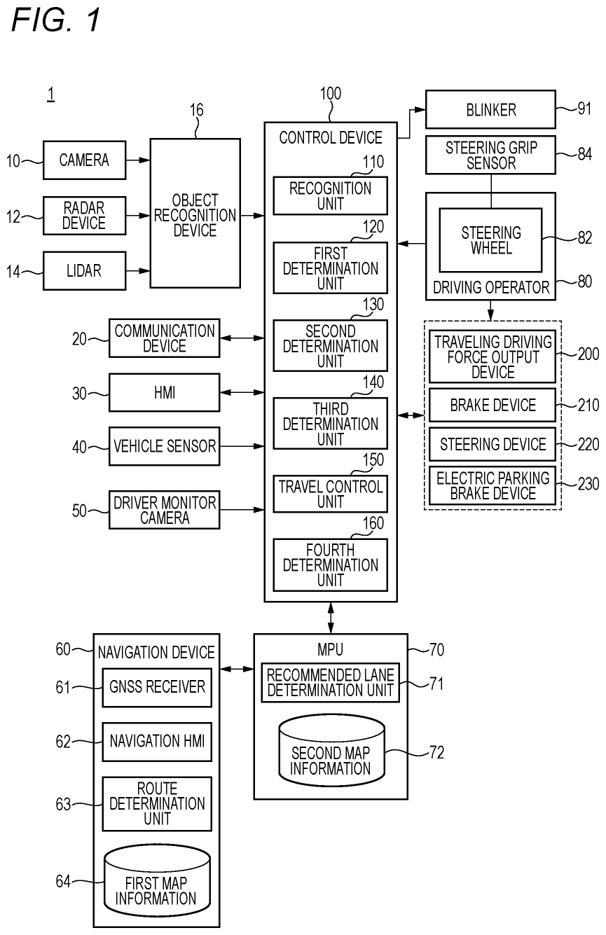

FIG. 1 is a block diagram showing an overall configuration of a vehicle system 1 including a control device 100 which is an embodiment of a vehicle control device of the present disclosure. Hereinafter, a vehicle on which the vehicle system 1 is mounted is also referred to as a “vehicle M1”. The vehicle M1 is, for example, an automobile such as two-wheeled vehicle, three-wheeled vehicle, or four-wheeled vehicle, and a drive source thereof is an internal combustion engine such as a diesel engine or a gasoline engine, an electric motor, or a combination thereof. The electric motor operates using electric power generated by an electrical generator connected to the internal combustion engine or electric power discharged from a secondary battery or a fuel cell.

The vehicle system 1 includes, for example, a camera 10, a radar device 12, a light detection and ranging (LIDAR) 14, an object recognition device 16, a communication device 20, a human machine interface (HMI) 30, a vehicle sensor 40, a driver monitor camera 50, a navigation device 60, a map positioning unit (MPU) 70, a driving operator 80, a blinker 91, the control device 100, a traveling driving force output device 200, a brake device 210, a steering device 220, and an electric parking brake device 230. These devices and equipment are connected to each other via, for example, a multiplex communication line such as a controller area network (CAN) communication line, a serial communication line, or a wireless communication network.

The camera 10 is, for example, a digital camera using a solid-state imaging element such as a charge coupled device (CCD) or a complementary metal oxide semiconductor (CMOS), and captures an image of the surroundings of the vehicle M1. The camera 10 is attached to any portion of the vehicle M1.

The radar device 12 radiates radio waves such as millimeter waves to the surroundings of the vehicle M1, and detects radio waves (reflected waves) reflected by an object to detect a position (a distance and an orientation) of the object at least. The radar device 12 is attached to any portion of the vehicle M1.

The LIDAR 14 emits light (or an electromagnetic wave having a wavelength close to that of light) around the vehicle M1 and measures scattered light. The LIDAR 14 detects the distance to a target based on time from light emission to light reception. The emitted light is, for example, pulsed laser light. The LIDAR 14 is attached to any portion of the vehicle M1. In addition, the vehicle M1 may not include the LIDAR 14.

The object recognition device 16 performs sensor fusion processing on some or all of detection results of the camera 10, the radar device 12, and the LIDAR 14 to recognize a position, a type, a speed, and the like of an object. The object recognition device 16 outputs a recognition result to the control device 100. The object recognition device 16 may output the detection results of the camera 10, the radar device 12, and the LIDAR 14 to the control device 100 as they are. When the vehicle M1 does not include the LIDAR 14, the object recognition device 16 may recognize the position of the object or the like by performing the sensor fusion processing on the detection results of the camera 10 and the radar device 12.

The communication device 20 uses, for example, a cellular network, a Wi-Fi (registered trademark) network, Bluetooth (registered trademark), or dedicated short range communication (DSRC) to communicate with other vehicles present in the surroundings of the vehicle M1 or communicate with various server devices via a radio base station.

The HMI 30 presents various types of information to an occupant of the vehicle M1 and receives an input operation by the occupant.

The vehicle sensor 40 includes a vehicle speed sensor that detects a travel speed (hereinafter also referred to as “vehicle speed”) of the vehicle M1, an acceleration sensor that detects an acceleration, a yaw rate sensor that detects an angular speed around a vertical axis, an azimuth sensor that detects a direction of the vehicle M1, and the like.

The driver monitor camera 50 is, for example, a digital camera using a solid-state imaging device such as a CCD or a CMOS. The driver monitor camera 50 is attached to any portion of the vehicle M1 in a position and a direction in which an image of a head of an occupant (hereinafter, also referred to as a “driver”) seated in a driver's seat of the vehicle M1 can be captured from the front (that is, in a direction in which an image of a face is captured).

The navigation device 60 includes, for example, a global navigation satellite system (GNSS) receiver 61, a navigation HMI 62, and a route determination unit 63. The navigation device 60 stores first map information 64 in a storage device such as a hard disk drive (HDD) or a flash memory.

The GNSS receiver 61 specifies the current position of the vehicle M1 based on a signal received from a GNSS satellite. The current position of the vehicle M1 may be specified or complemented by an inertial navigation system (INS) using the output of the vehicle sensor 40.

The navigation HMI 62 includes a display device, a speaker, a touch panel, keys, and the like. The navigation HMI 62 may be partially or entirely shared with the HMI 30 described above.

For example, the route determination unit 63 determines a route (hereinafter, also referred to as a “route on a map”) from the position of the vehicle M1 specified by the GNSS receiver 61 (or an input any position) to a destination input by the occupant using the navigation HMI 62 with reference to the first map information 64. The first map information 64 is, for example, information in which a road shape is expressed by links indicating roads and nodes connected by the links. The first map information 64 may include a curvature of a road, point of interest (POI) information, and the like. The route on the map is output to the MPU 70.

The navigation device 60 may perform route guidance using the navigation HMI 62 based on the route on the map. The navigation device 60 may transmit the current position and the destination to a navigation server via the communication device 20 and obtain a route equivalent to the route on the map from the navigation server.

The MPU 70 includes, for example, a recommended lane determination unit 71, and stores second map information 72 in a storage device such as an HDD or a flash memory. The recommended lane determination unit 71 divides the route on the map provided from the navigation device 60 into a plurality of blocks (for example, divides the route on the map by 100 [m] in a vehicle traveling direction), and determines a recommended lane for each block with reference to the second map information 72. For example, the recommended lane determination unit 71 determines which lane from the left the vehicle is to travel in. When there is a branch point in the route on the map, the recommended lane determination unit 71 determines a recommended lane such that the vehicle M1 can travel along a reasonable route for advancing to a branch destination.

The second map information 72 is map information with higher accuracy than the first map information 64. The second map information 72 includes, for example, lane type information (a straight traveling exclusive lane, a right-turn exclusive lane, a left-turn exclusive lane, and the like), information on a center of the lane, information on a boundary of the lane, and the like. The second map information 72 may include road information, traffic regulation information, address information, facility information, telephone number information, and the like. The second map information 72 may be updated as needed by the communication device 20 communicating with another device.

The driving operator 80 includes, for example, a blinker lever, an accelerator pedal, a brake pedal, a shift lever, and other operators in addition to a steering wheel 82. A sensor that detects an operation amount or presence or absence of an operation is attached to the driving operator 80, and a detection result thereof is output to some or all of the control device 100, the traveling driving force output device 200, the brake device 210, and the steering device 220.

The steering wheel 82 is not necessarily in an annular shape, and may be in a form of irregular steering, joy stick, a button, or the like. A steering grip sensor 84 is attached to the steering wheel 82. The steering grip sensor 84 is realized by a static capacitance sensor or the like, and outputs, to the control device 100, a signal capable of detecting whether the driver is gripping the steering wheel 82.

The blinker 91 is a direction indicator implemented by a lamp (lamp body) or the like provided on each of a left side (for example, left front and left rear) and a right side (for example, right front and right rear) of the vehicle M1 so as to be visible from the outside of the vehicle M1. The blinker 91 is turned on or off in accordance with an operation of the blinker lever provided so as to be operable by the driver.

The traveling driving force output device 200 outputs, to wheels (specifically, driving wheels such as front wheels), a traveling driving force (torque) for the vehicle M1 to travel. The traveling driving force output device 200 includes, for example, a combination of an internal combustion engine, an electric motor, a transmission, and the like, and an electronic control unit (ECU) that controls the combination. The ECU of the traveling driving force output device 200 controls the above-described configuration in accordance with information input from the control device 100 or information input from the driving operator 80.

The brake device 210 includes, for example, a brake caliper, a cylinder that transmits a hydraulic pressure to the brake caliper, an electric motor that generates the hydraulic pressure in the cylinder, and a brake ECU. The brake ECU controls the electric motor of the brake device 210 in accordance with the information input from the control device 100 or the information input from the driving operator 80, and outputs a brake torque according to a braking operation to each wheel.

The steering device 220 includes, for example, a steering ECU and an electric motor. The electric motor of the steering device 220 changes the direction of a steering wheel, for example, by applying a force to a rack-and-pinion mechanism. The steering ECU drives the electric motor of the steering device 220 in accordance with the information input from the control device 100 or the information input from the driving operator 80 to change the direction of the steering wheel.

The electric parking brake device 230 includes, for example, an electric motor that generates a gripping force (braking force) acting on a brake caliper by driving a brake pad so as to grip the brake caliper of the wheel (for example, a rear wheel, that is, a non-driving wheel) of the vehicle M1, and an electric parking brake ECU (hereinafter also referred to as an “EPB-ECU”). The EPB-ECU controls the electric motor of the electric parking brake device 230 in accordance with the information input from the control device 100 or the information input from the driving operator 80 to fix the wheels of the vehicle M1. That is, the electric parking brake device 230 is configured to fix the wheels by electronic control.

### <Control Device>

The control device 100 is a computer that integrally controls the entire vehicle M1, and includes, for example, a recognition unit 110, a first determination unit 120, a second determination unit 130, a third determination unit 140, a travel control unit 150, and a fourth determination unit 160.

Each functional unit of the recognition unit 110, the first determination unit 120, the second determination unit 130, the third determination unit 140, the travel control unit 150, and the fourth determination unit 160 is realized by, for example, a hardware processor such as a central processing unit (CPU) executing a predetermined program (software). Some or all of these may be implemented by hardware (including circuitry) such as a large scale integration (LSI), an application specific integrated circuit (ASIC), a field-programmable gate array (FPGA), and a graphics processing unit (GPU), or may be implemented by cooperation of software and hardware. The program may be stored in advance in a storage device such as an HDD or a flash memory of the control device 100.

The recognition unit 110 recognizes a surrounding situation of the vehicle M1 based on information input from the camera 10, the radar device 12, and the LIDAR 14 via the object recognition device 16. For example, the recognition unit 110 recognizes a moving state such as a speed and/or an acceleration of an object in addition to a position of the object around the vehicle M1. For example, the position of the object is recognized as a position on absolute coordinates with a representative point (a center of gravity, a drive shaft center, or the like) of the vehicle M1 as an origin, and is used for control. The position of the object may be represented by a representative point such as a center of gravity or a corner of the object, or may be represented by an area.

An example of the object recognized by the recognition unit 110 is a traffic participant present around the vehicle M1. Here, the traffic participant includes, for example, a pedestrian, a cycle, and the like in addition to another vehicle M2 which is an automobile different from the vehicle M1. When the other vehicle M2 is recognized, the recognition unit 110 can also recognize whether a predetermined out-of-vehicle notification is performed in the other vehicle M2. Here, the out-of-vehicle notification includes, for example, notification by a direction indicator, a hazard lamp, a stop display plate, or a flame generating cylinder.

Another example of the object recognized by the recognition unit 110 is a feature related to traffic such as a road partition line, a road sign, a crosswalk CW, and a traffic signal SG. Furthermore, when recognizing the traffic light SG, the recognition unit 110 can also recognize which of a green signal light SG_G, a yellow signal light SG_Y, and a red signal light SG_R included in the traffic light SG is turned on. Here, the green signal light SG_G is a signal light indicating that the vehicle can travel beyond a predetermined stop position. The yellow signal light SG_Y is a signal light indicating that the vehicle does not advance beyond the predetermined stop position except when the vehicle cannot safely stop. Further, the red signal light SG_R is a signal light indicating that the vehicle should not travel beyond the predetermined stop position.

For example, the recognition unit 110 compares lane information included in the second map information 72 of the MPU 70 with the road partition line recognized from an image captured by the camera 10 to recognize a lane on which the vehicle M1 is currently located (hereinafter, also referred to as a “first vehicle lane”) or another lane adjacent to the first vehicle lane (for example, an adjacent lane L2 to be described later). In this recognition, the current position of the vehicle M1 obtained from the navigation device 60 or a processed result by the INS may be added.

The first determination unit 120 determines whether there is the crosswalk CW in a scheduled traveling lane L1 of the vehicle M1 that is traveling or starts traveling based on the recognition result of the recognition unit 110, and passes the determination result to the third determination unit 140. As an example, the first determination unit 120 determines whether there is a crosswalk CW in the scheduled traveling lane L1 of the vehicle M1 when the vehicle M1 is traveling by autonomous driving that does not require a driver's operation (that is, when the vehicle speed is greater than 0). As another example, the first determination unit 120 may perform the above-described determination by causing the vehicle M1 to start traveling when the green signal light SG_G is turned on in a traffic light SG ahead of the vehicle M1 during autonomous driving. Note that traveling by autonomous driving that does not require a driver's operation is hereinafter also referred to as “autonomous traveling”.

The scheduled traveling lane L1 can be, for example, a first vehicle lane on which the vehicle M1 is currently located. When a lane change is included in a traveling plan of the vehicle M1 by autonomous driving, the scheduled traveling lane L1 may be a lane of a movement destination by the lane change.

The second determination unit 130 determines whether there is an adjacent lane L2 that is adjacent to the scheduled traveling lane L1 and has the same traveling direction as the scheduled traveling lane L1 based on the recognition result of the recognition unit 110 or map information prepared in advance, and passes the determination result to the third determination unit 140. For example, the second determination unit 130 can determine whether there is an adjacent lane L2 with reference to the lane information included in the second map information 72 of the MPU 70 and information on another lane adjacent to the first vehicle lane recognized by the recognition unit 110.

For example, when the first determination unit 120 determines that there is the crosswalk CW and the second determination unit 130 determines that there is the adjacent lane L2, the third determination unit 140 determines whether there is the other vehicle M2 that is on the adjacent lane L2 and stopped in front of the crosswalk CW when viewed from the vehicle M1 based on the recognition result of the recognition unit 110. Then, the third determination unit 140 passes the determination result to the travel control unit 150.

From a viewpoint of preventing occurrence of excessive restraint of the vehicle speed in the vehicle M1, when the first determination unit 120 determines that there is the crosswalk CW and the second determination unit 130 determines that there is the adjacent lane L2, the third determination unit 140 may determine whether there is another vehicle M2 that is on the adjacent lane L2, is stopped in front of the crosswalk CW when viewed from the vehicle M1, and is within a predetermined distance from the crosswalk CW, based on the recognition result of the recognition unit 110. In this way, it is possible to prevent the vehicle speed of the vehicle M1 from being restrained based on the other vehicle M2 that is stopped at a position far away from the crosswalk CW, that is, the other vehicle M2 that is highly likely to be stopped due to a stop factor unrelated to the presence or absence of a traffic participant who is crossing or is going to cross the crosswalk CW.

From the same viewpoint as described above, when the first determination unit 120 determines that there is the crosswalk CW and the second determination unit 130 determines that there is the adjacent lane L2, the third determination unit 140 may determine whether there is the other vehicle M2 that is on the adjacent lane L2, is stopped in front of the crosswalk CW when viewed from the vehicle M1, and does not perform the out-of-vehicle notification described above based on the recognition result of the recognition unit 110. Even in this case, it is possible to prevent the vehicle speed of the vehicle M1 from being restrained based on the other vehicle M2 that is highly likely to be stopped due to a stop factor unrelated to the presence or absence of a traffic participant who is crossing or is going to cross the crosswalk CW.

When the third determination unit 140 determines that there is the other vehicle M2 satisfying the above condition, the travel control unit 150 performs restraint control (hereinafter, also referred to as “vehicle speed restraint control”) of restraining the travel speed (that is, the vehicle speed) of the vehicle M1. As an example, when the vehicle speed restraint control is performed, the travel control unit 150 causes the vehicle M1 during autonomous traveling to slow down. Here, slow traveling refers to causing the vehicle M1 to travel at a vehicle speed (for example, 10 km/h or less) at which the vehicle M1 can be immediately stopped.

That is, when there is the other vehicle M2 stopped in front of the crosswalk CW, it is assumed that there is a traffic participant (for example, a pedestrian) who is crossing or is going to cross the crosswalk CW. Here, when there is the other vehicle M2 stopped in front of the crosswalk CW on the adjacent lane L2, by restraining the vehicle speed of the vehicle M1, it is possible to realize control in consideration of safety provided in jumping out of the traffic participant from a shadow of the other vehicle M2 to the scheduled traveling lane L1 of the vehicle M1. Accordingly, it is possible to improve traffic safety and contribute to development of a sustainable transportation system.

The control device 100 may further include the fourth determination unit 160. Here, when the vehicle speed restraint control is being performed by the travel control unit 150, the fourth determination unit 160 determines whether a predetermined end condition for ending the vehicle speed restraint control is satisfied, and passes the determination result to the travel control unit 150. When the fourth determination unit 160 determines that the end condition is satisfied, the travel control unit 150 ends the vehicle speed restraint control.

As an example, the fourth determination unit 160 may determine that the end condition is satisfied when it is determined that there is no traffic participant in at least a predetermined range on the crosswalk CW based on the recognition result of the recognition unit 110. Here, the predetermined range includes a portion of the crosswalk CW overlapping the scheduled traveling lane L1 and a portion of the crosswalk CW overlapping the adjacent lane L2 adjacent to the scheduled traveling lane L1. That is, the fourth determination unit 160 may determine that the end condition is satisfied when it is confirmed that there is no traffic participant such as a pedestrian in a portion of the crosswalk CW overlapping the scheduled traveling lane L1 and a portion of the crosswalk CW overlapping the adjacent lane L2. Accordingly, when it is confirmed that there is a low possibility that the traffic participant jumps out from the shadow of the other vehicle M2 to the scheduled traveling lane L1 of the vehicle M1, it is possible to end the vehicle speed restraint control.

As another example, the fourth determination unit 160 may determine that the end condition is satisfied when the vehicle M1 passes through the crosswalk CW. In this way, it is possible to prevent a situation in which a state in which the travel speed of the vehicle M1 is restrained continues even though the vehicle M1 has passed through the crosswalk CW and the convenience for the user decreases.

### <Specific Example of Control by Control Device>

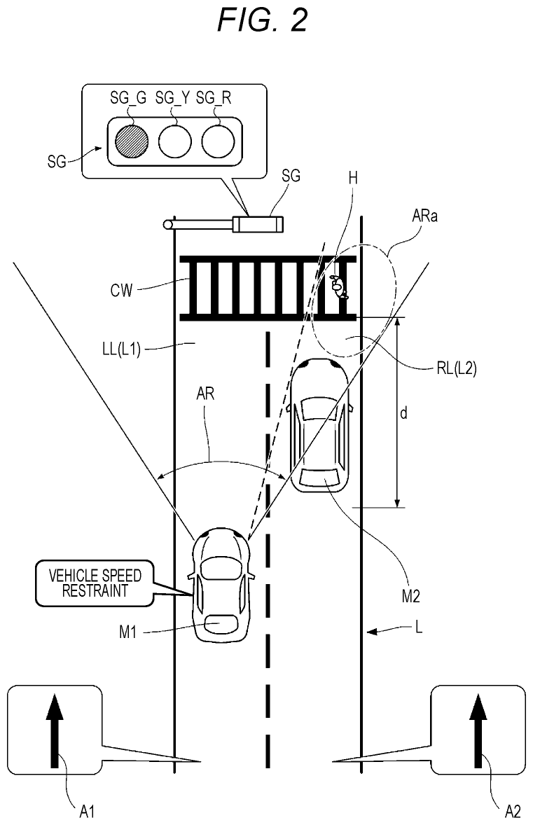

Next, specific examples of the control by the control device 100 will be described with reference to FIGS. 2 to 5.

First, in each example shown in FIGS. 2 to 5, common contents will be described. In FIGS. 2 to 5, a road L is a road having two lanes in each direction, and has a left lane LL which is a lane on a left side of the two lanes and a right lane RL which is a lane on a right side of the two lanes. An arrow indicated by a reference numeral A1 indicates a traveling direction of the left lane LL, and an arrow indicated by a reference numeral A2 indicates a traveling direction of the right lane RL.

The vehicle M1 is autonomously traveling in the left lane LL, and the left lane LL (more specifically, in front of the vehicle M1 in the left lane LL) is the scheduled traveling lane L1. The crosswalk CW is present in the scheduled traveling lane L1, and the green signal light SG_G is turned on in the traffic light SG ahead of the vehicle M1.

A detectable area AR shown in FIG. 2 and the like represents an area in which the recognition unit 110 can recognize (that is, detect) a traffic participant in front of the vehicle M1 based on information obtained by the camera 10, the radar device 12, the LIDAR 14, or the like of the vehicle M1.

Hereinafter, each example shown in FIGS. 2 to 5 will be described. In the example shown in FIG. 2, since the right lane RL is a lane that is adjacent to the left lane LL that is the scheduled traveling lane L1 and has the same traveling direction as the left lane LL (see arrows indicated by the reference numerals A1 and A2), the right lane RL is the adjacent lane L2. Although there is the crosswalk CW in the scheduled traveling lane L1 of the vehicle M1 and the green signal light SG_G is turned on in the traffic light SG ahead of the vehicle M1, the other vehicle M2 in the adjacent lane L2 is stopped in front of the crosswalk CW.

Here, the stop position of the other vehicle M2 is within a predetermined distance d from the crosswalk CW, and a part of the other vehicle M2 being stopped enters a part of the detectable area AR of the vehicle M1 traveling toward the crosswalk CW. Therefore, an area ARa (hereinafter, also referred to as a “blind spot area”) as a shaded portion of the other vehicle M2 when viewed from the vehicle M1 is generated. The blind spot area ARa overlaps a part of the crosswalk CW. Accordingly, even when there is a traffic participant such as a pedestrian H crossing the crosswalk CW in a portion overlapping the blind spot area ARa of the crosswalk CW, the control device 100 cannot recognize the traffic participant. Therefore, in such a case, it is desirable to perform the control in consideration of safety provided in jumping out of the traffic participant to from the blind spot area ARa.

In the case of this example, the first determination unit 120 of the control device 100 determines that there is the crosswalk CW in the scheduled traveling lane L1, and the second determination unit 130 determines that there is the adjacent lane L2 having the same traveling direction as the scheduled traveling lane L1. In addition, the third determination unit 140 determines that there is the other vehicle M2 that is on the adjacent lane L2, is stopped in front of the crosswalk CW when viewed from the vehicle M1, and is within a predetermined distance d from the crosswalk CW based on the recognition result of the recognition unit 110. Then, based on the fact that the third determination unit 140 determines that there is the other vehicle M2, the travel control unit 150 performs vehicle speed restraint control to restrain the vehicle speed of the vehicle M1.

In this way, when the other vehicle M2 stopped in front of the crosswalk CW is present on the adjacent lane L2 in the same traveling direction as the scheduled traveling lane L1 of the vehicle M1, by restraining the vehicle speed of the vehicle M1, it is possible to realize the control in consideration of safety provided in jumping out of the traffic participant (for example, the pedestrian H) from the shadow (for example, the blind spot area ARa) of the other vehicle M2 to the scheduled traveling lane L1. Accordingly, it is possible to improve the traffic safety and contribute to the development of the sustainable transportation system.

For example, the control device 100 performs the vehicle speed restraint control based on the fact that the stopped other vehicle M2 is present within the predetermined distance d from the crosswalk CW, and restrains the vehicle speed of the vehicle M1.

Accordingly, it is possible to prevent the vehicle speed of the vehicle M1 from being restrained based on the other vehicle M2 that is stopped at a position far away from the crosswalk CW, that is, the other vehicle M2 that is highly likely to be stopped due to a stop factor unrelated to the presence or absence of the traffic participant (for example, the pedestrian H) who is crossing or is going to cross the crosswalk CW. Accordingly, it is possible to prevent occurrence of excessive restraint of the vehicle speed in the vehicle M1.

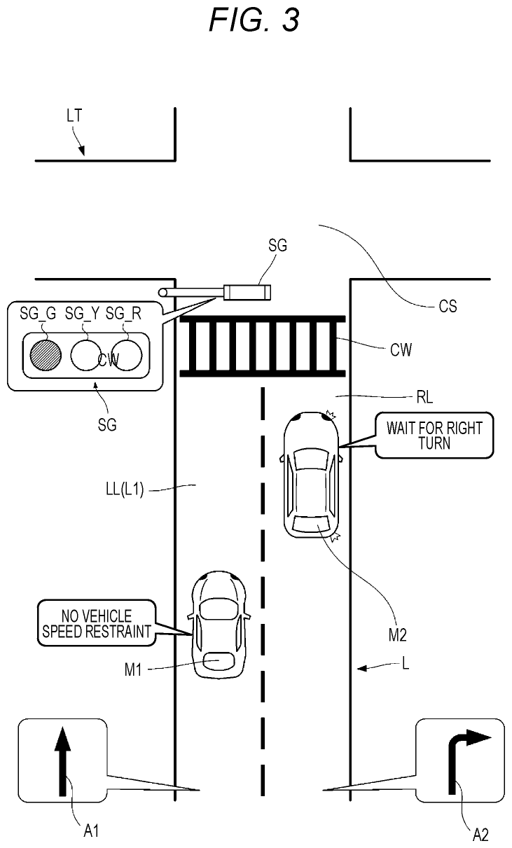

The example shown in FIG. 3 is different from the example shown in FIG. 2 in that the crosswalk CW is provided at a crossing point CS at which the road L and the other road LT cross each other, and the right lane RL is a right-turn exclusive lane at the crossing point CS. In this case, since the traveling direction of the right lane RL after the crossing point CS is different from that of the left lane LL, the right lane RL does not correspond to the adjacent lane L2 described above. Therefore, in the case of this example, as shown in FIG. 3, even when the other vehicle M2 is present in front of the crosswalk CW when viewed from the vehicle M1 in the right lane RL, the third determination unit 140 makes a negative determination, and the vehicle speed restraint control by the travel control unit 150 is not performed.

On the other hand, in the example shown in FIG. 3, if the right lane RL is not the right-turn exclusive lane at the crossing point CS, but is a lane included in the road L even after the crossing point CS similarly to the left lane LL (in other words, a lane in which the vehicle can be advanced at the crossing point CS in a road L direction), the right lane RL corresponds to the adjacent lane L2 described above, and the vehicle speed restraint control is performed by the travel control unit 150.

In this way, when the crosswalk CW of the scheduled traveling lane L1 is provided at the crossing point CS, the vehicle speed restraint control is performed based on that the scheduled traveling lane L1 and the adjacent lane L2 are lanes included in one road (for example, the road L shown in FIG. 3) both in front of and behind the crossing point CS, so that it is possible to prevent the vehicle speed of the vehicle M1 from being restrained based on the other vehicle M2 (for example, another vehicle M2 waiting for a right turn as shown in FIG. 3) on a lane in which the other vehicle M2 is to be advanced to another road called a right-turn exclusive lane, for example. Accordingly, it is possible to prevent the occurrence of excessive restraint of the vehicle speed in the vehicle M1.

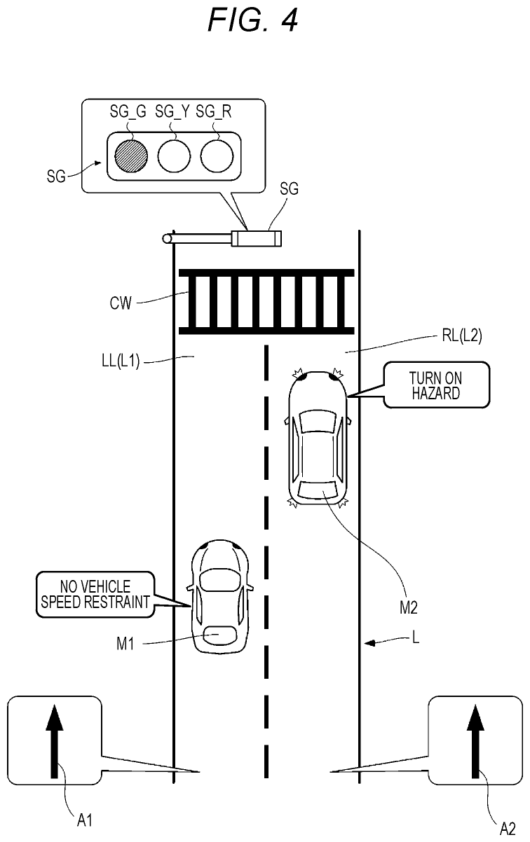

The example shown in FIG. 4 is different from the example shown in FIG. 2 in that the other vehicle M2 stopped in front of the crosswalk CW performs the out-of-vehicle notification of turning on the hazard lamp. In this case, since the other vehicle M2 stopped in front of the crosswalk CW performs the out-of-vehicle notification of turning on the hazard lamp, the third determination unit 140 makes a negative determination, and the vehicle speed restraint control by the travel control unit 150 is not performed.

In this way, even when there is the other vehicle M2 stopped in front of the crosswalk CW, when the other vehicle M2 performs the predetermined out-of-vehicle notification such as turning on the hazard lamp, it is possible to prevent the vehicle speed of the vehicle M1 from being restrained based on the other vehicle M2 that is stopped due to the stop factor unrelated to the presence or absence of the traffic participant (for example, the pedestrian H) who is crossing or is going to cross the crosswalk, rather than restraining the vehicle speed of the vehicle M1. Accordingly, it is possible to prevent the occurrence of excessive restraint of the vehicle speed in the vehicle M1.

In the example shown in FIG. 4, the vehicle speed restraint control is not performed when the other vehicle M2 stopped in front of the crosswalk CW performs the out-of-vehicle notification in which the hazard lamp is turned on, but the present disclosure is not limited thereto. For example, in the other vehicle M2 stopped in front of the crosswalk CW, the vehicle speed restraint control may not be performed even when the out-of-vehicle notification is performed by the direction indicator, the stop display plate, the flame generating cylinder, or the like. For example, the vehicle speed restraint control may not be performed when there is a traffic guide person who instructs to overtake the other vehicle M2 stopped in front of the crosswalk CW. Alternatively, when a following vehicle of the other vehicle M2 stopped in front of the crosswalk CW exhibits a behavior of overtaking the other vehicle M2, the vehicle speed restraint control may not be performed. That is, in this case, this is because it is considered that there is a high possibility that the other vehicle M2 is stopped for a reason other than the presence or absence of the traffic participant (for example, the pedestrian H) who is crossing or is going to cross the crosswalk.

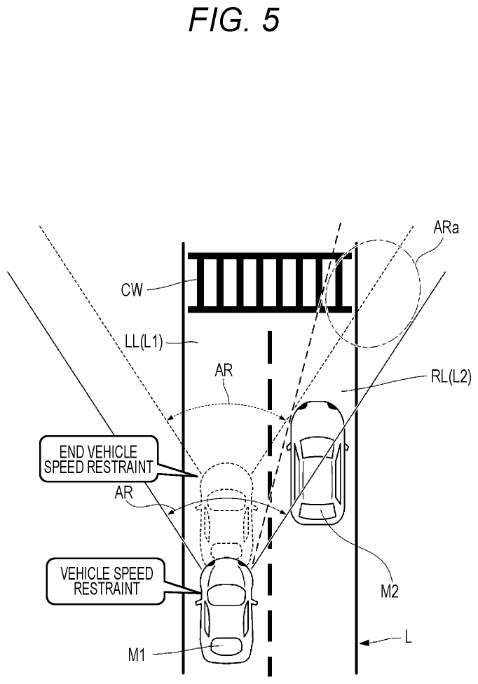

The example shown in FIG. 5 is an example in which the vehicle speed restraint control is ended. In FIG. 5, when the vehicle M1 is at a position indicated by a solid line, since a part of the other vehicle M2 being stopped enters a part of the detectable area AR of the vehicle M1 traveling toward the crosswalk CW, the blind spot area ARa is generated as indicated by a broken line. The blind spot area ARa overlaps a part of the crosswalk CW. Accordingly, in this case, the control device 100 (the travel control unit 150) performs the vehicle speed restraint control as in the example shown in FIG. 2.

After the start of the vehicle speed restraint control, the fourth determination unit 160 determines whether it has been confirmed that there is no traffic participant such as a pedestrian in a portion overlapping the scheduled traveling lane L1 of the crosswalk CW and a portion overlapping the adjacent lane L2. In the present example, since at a time when the vehicle M1 moves to a position indicated by the dotted line, the entire crosswalk CW including the portion overlapping the scheduled traveling lane L1 of the crosswalk CW and the portion overlapping the adjacent lane L2 enters the detectable area AR and it is confirmed that there is no traffic participant such as a pedestrian in the crosswalk CW, the fourth determination unit 160 determines that the end condition of the vehicle speed restraint control is satisfied. Based on the determination result, the travel control unit 150 ends the vehicle speed restraint control.

In this way, it is confirmed that there is no traffic participant such as a pedestrian in both the portion overlapping the scheduled traveling lane L1 of the crosswalk CW and the portion overlapping the adjacent lane L2, the vehicle speed restraint control is ended, and therefore it is possible to end the vehicle speed restraint control when there is a low possibility that the traffic participant jumps out from the shadow of the other vehicle M2 to the scheduled traveling lane L1 of the vehicle M1.

In the example shown in FIG. 5, even when it is not possible to confirm that there is no traffic participant in the crosswalk CW, when the vehicle M1 passes through the crosswalk CW, the fourth determination unit 160 may determine that the end condition of the vehicle speed restraint control is satisfied. Based on the determination result, the travel control unit 150 may end the vehicle speed restraint control. Accordingly, it is possible to prevent a situation in which a state in which the vehicle speed of the vehicle M1 is restrained continues even though the vehicle M1 has passed through the crosswalk CW and the convenience for the user decreases.

### <Example of Processing Performed by Control Device 100>

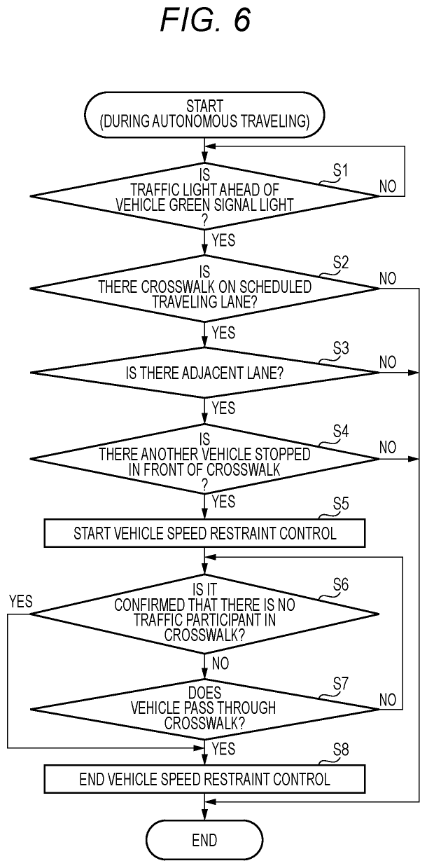

Next, an example of processing performed by the control device 100 will be described with reference to FIG. 6. For example, the control device 100 performs the processing shown in FIG. 6 at a predetermined cycle during autonomous traveling of the vehicle M1. During autonomous traveling of the vehicle M1, in addition to the processing shown in FIG. 6, when the control device 100 detects (that is, recognizes) an object that may collide with the vehicle M1, the control device 100 performs processing (not shown) of realizing collision avoidance control in which braking and/or steering of the vehicle M1 are performed to avoid collision between the object and the vehicle M1.

As shown in FIG. 6, first, the control device 100 determines whether the green signal light SG_G is turned on in the traffic light SG ahead of the vehicle M1 (step S1). When it is determined that the green signal light SG_G is not turned on (step S1: NO), the control device 100 repeats the process of step S1.

On the other hand, when it is determined that the green signal light SG_G is turned on (step S1: YES), the control device 100 determines whether there is a crosswalk CW in the scheduled traveling lane L1 of the vehicle M1 (step S2). When it is determined that there is no crosswalk CW in the scheduled traveling lane L1 (step S2: NO), the control device 100 ends the processing shown in FIG. 6 as it is.

On the other hand, when it is determined that there is the crosswalk CW (step S2: YES), the control device 100 determines whether there is the adjacent lane L2 (step S3). When it is determined that there is no adjacent lane L2 (step S3: NO), the control device 100 ends the processing shown in FIG. 6 as it is.

When it is determined that there is the adjacent lane L2 (step S3: YES), it is determined whether there is the other vehicle M2 that is on the adjacent lane L2 and is stopped in front of the crosswalk CW (step S4). When it is determined that there is no corresponding other vehicle M2 (step S4: NO), the control device 100 ends the processing shown in FIG. 6 as it is. On the other hand, when it is determined that there is the other vehicle M2 (step S4: YES), the control device 100 starts the vehicle speed restraint control for restraining the vehicle speed of the vehicle M1 (step S5).

Then, the control device 100 determines whether it is confirmed that there is no traffic participant in the crosswalk CW (step S6). When it is confirmed that there is no traffic participant in the crosswalk CW (step S6: YES), the control device 100 proceeds to the process of step S8.

On the other hand, when it is not confirmed that there is no traffic participant in the crosswalk CW (step S6: NO), the control device 100 determines whether the vehicle M1 has passed through the crosswalk CW (step S7). When it is determined that the vehicle has passed through the crosswalk CW (step S7: YES), the vehicle speed restraint control ends (step S8), and the processing shown in FIG. 6 ends.

As described above, according to the present embodiment, when the other vehicle M2 stopped in front of the crosswalk CW is present on the adjacent lane L2 in the same traveling direction as the scheduled traveling lane L1 of the vehicle M1, by performing the vehicle speed restraint control for restraining the vehicle speed of the vehicle M1, it is possible to realize the control in consideration of safety provided in jumping out of the traffic participant from the shadow of the other vehicle M2 to the scheduled traveling lane L1 of the vehicle M1. Accordingly, it is possible to improve the traffic safety and contribute to the development of the sustainable transportation system.

The present disclosure is not limited to the embodiment described above. It is apparent that those skilled in the art may conceive of various modifications and changes within the scope described in the claims, and it is understood that such modifications and changes naturally fall within the technical scope of the present disclosure. In addition, the constituent elements in the embodiment described above may be freely combined without departing from the gist of the disclosure.

In the embodiment described above, an example in which the vehicle control device according to the present disclosure is realized by the control device 100 mounted on the vehicle M1 has been described, but the present disclosure is not limited thereto. For example, the vehicle control device according to the present disclosure may be realized by a server capable of communicating with the control device 100. In this case, for example, each processing of the control device 100 described above may be performed by a processing unit realized by a CPU or the like of a server. The vehicle control device according to the present disclosure may be realized by cooperation between the control device 100 and a server, and for example, a part of the processing of the control device 100 described above may be performed by the server.

The control method described in the embodiment described above can be realized by executing a program prepared in advance on a computer. The program (a control program) is stored in a computer-readable storage medium and is executed by being read from the storage medium. In addition, the program may be provided in a form stored in a nonvolatile (non-transitory) storage medium such as a flash memory, or may be provided via a network such as Internet. The computer that executes the program may be included in the vehicle M1 or may be included in an external device (for example, a server) capable of communicating with the vehicle M1.

In the present specification and the like, at least the following matters are described. Although corresponding constituent elements and the like in the embodiment described above are shown in parentheses, the present disclosure is not limited thereto.

(1) A vehicle control device (control device 100) that controls a vehicle (vehicle M1), the vehicle control device including:
a recognition unit (recognition unit 110) configured to recognize a surrounding situation of the vehicle;
a first determination unit (first determination unit 120) configured to determine whether there is a crosswalk (crosswalk CW) in a scheduled traveling lane (scheduled traveling lane L1) of the vehicle that is traveling or starts traveling, based on a recognition result of the recognition unit;
a second determination unit (second determination unit 130) configured to determine whether there is an adjacent lane (adjacent lane L2) that is adjacent to the scheduled traveling lane and has the same traveling direction as the scheduled traveling lane, based on the recognition result of the recognition unit or map information (second map information 72) prepared in advance;
a third determination unit (third determination unit 140) configured to, when the first determination unit determines that there is the crosswalk and the second determination unit determines that there is the adjacent lane, determine, based on the recognition result of the recognition unit, whether there is another vehicle (another vehicle M2) that is on the adjacent lane and is stopped in front of the crosswalk when viewed from the vehicle; and
a travel controller (travel control unit 150) configured to perform restraint control for restraining a travel speed of the vehicle when the third determination unit determines that there is the another vehicle.

When there is the another vehicle stopped in front of the crosswalk, it is assumed that there is a traffic participant who is crossing or is going to cross the crosswalk. According to (1), when the another vehicle stopped in front of the crosswalk is present on the adjacent lane in the same traveling direction as the scheduled traveling lane of the vehicle, the travel speed of the vehicle is restrained. As a result, it is possible to realize control in consideration of safety provided in jumping out of the traffic participant from the shadow of the another vehicle to the scheduled traveling lane of the vehicle. Accordingly, it is possible to improve traffic safety and contribute to development of a sustainable transportation system.

(2) The vehicle control device according to (1),
wherein the crosswalk is a crosswalk provided at a crossing point (crossing point CS) at which one road (road L) and another road (road LT) cross each other, and
wherein the scheduled traveling lane and the adjacent lane are lanes included in the one road both in front of and behind the crossing point.

According to (2), for example, it is possible to prevent the travel speed of the vehicle from being restrained based on the another vehicle on the lane in which the vehicle travels from one road, which is the right-turn exclusive lane, to the other road. As a result, it is possible to realize control in which deterioration of user convenience is prevented while safety is taken into consideration.

(3) The vehicle control device according to (1) or (2),
wherein when the first determination unit determines that there is the crosswalk and the second determination unit determines that there is the adjacent lane, the third determination unit determines whether there is the another vehicle that is on the adjacent lane, is stopped in front of the crosswalk when viewed from the vehicle, and is within a predetermined distance from the crosswalk, based on the recognition result of the recognition unit.

When the another vehicle is stopped at a position far away from the crosswalk, there is a high possibility that the stop factor is not related to the presence or absence of a traffic participant who is crossing or is going to cross the crosswalk. According to (3), since the travel speed of the vehicle is restrained when the another vehicle is stopped within the predetermined distance from the crosswalk, it is possible to prevent the travel speed of the vehicle from being restrained based on the another vehicle that is stopped due to a stop factor unrelated to the presence or absence of the traffic participant who is crossing or is going to cross the crosswalk. As a result, it is possible to realize control in which deterioration of user convenience is prevented while safety is taken into consideration.

(4) The vehicle control device according to any one of (1) to (3),
wherein when the first determination unit determines that there is the crosswalk and the second determination unit determines that there is the adjacent lane, the third determination unit determines whether there is the another vehicle that is on the adjacent lane, is stopped in front of the crosswalk when viewed from the vehicle, and does not perform a predetermined out-of-vehicle notification, based on the recognition result of the recognition unit.

When the another vehicle that is stopped performs the predetermined out-of-vehicle notification, there is a high possibility that the stop factor is not related to the presence or absence of the traffic participant who is crossing or is going to cross the crosswalk. According to (4), since the travel speed of the vehicle is restrained when the another vehicle does not perform the out-of-vehicle notification, it is possible to prevent the travel speed of the vehicle from being restrained based on the another vehicle that is stopped due to the stop factor unrelated to the presence or absence of the traffic participant who is crossing or is going to cross the crosswalk. As a result, it is possible to realize control in which deterioration of user convenience is prevented while safety is taken into consideration.

(5) The vehicle control device according to (4),
wherein the out-of-vehicle notification is a notification by a direction indicator, a hazard lamp, a stop display plate or a flame generating cylinder.

It is highly likely that a stop factor of the another vehicle performing the out-of-vehicle notification by a direction indicator, a hazard lamp, a stop display plate, or a flame generating cylinder is not related to the presence or absence of the traffic participant who is crossing or is going to cross the crosswalk. According to (5), it is possible to prevent the travel speed of the vehicle from being restrained based on the another vehicle that is stopped due to the stop factor unrelated to the presence or absence of the traffic participant who is crossing or is going to cross the crosswalk.

(6) The vehicle control device according to any one of (1) to (5),
wherein the vehicle control device further includes a fourth determination unit configured to determine whether a predetermined end condition for ending the restraint control is satisfied when the restraint control is being performed by the travel controller, and
wherein the travel controller ends the restraint control when the fourth determination unit determines that the end condition is satisfied.

According to (6), since the restraint control ends when the predetermined end condition is satisfied, it is possible to prevent a situation in which a state in which the travel speed of the vehicle is restrained by the restraint control continues and the convenience for the user decreases.

(7) The vehicle control device according to (6),
wherein the fourth determination unit determines that the end condition is satisfied when it is determined that there is no traffic participant in at least a predetermined range of the crosswalk based on the recognition result of the recognition unit, and
wherein the predetermined range includes a portion of the crosswalk overlapping the scheduled traveling lane and a portion of the crosswalk overlapping the adjacent lane.

According to (7), it is possible to end the restraint control when it is confirmed that there is a low possibility that the traffic participant jumps out from the shadow of the another vehicle to the scheduled traveling lane of the vehicle.

(8) The vehicle control device according to (6) or (7),
wherein the fourth determination unit determines that the end condition is satisfied when the vehicle passes through the crosswalk.

According to (8), it is possible to prevent a situation in which a state in which the travel speed of the vehicle is restrained continues even though the vehicle has passed through the crosswalk, and the convenience of the user decreases.

(9) A control method performed by a computer that controls a vehicle, the control method including: by the computer,
recognizing a surrounding situation of the vehicle;
determining whether there is a crosswalk in a scheduled traveling lane of the vehicle that is traveling or starts traveling, based on a recognition result of the surrounding situation;
determining whether there is an adjacent lane that is adjacent to the scheduled traveling lane and has the same traveling direction as the scheduled traveling lane, based on the recognition result of the surrounding situation or map information prepared in advance;
determining, when it is determined that there is the crosswalk and there is the adjacent lane, whether there is another vehicle that is on the adjacent lane and is stopped in front of the crosswalk when viewed from the vehicle, based on the recognition result of the surrounding situation; and
performing restraint control for restraining a travel speed of the vehicle when it is determined that there is the another vehicle.

When there is the another vehicle stopped in front of the crosswalk, it is assumed that there is a traffic participant who is crossing or is going to cross the crosswalk. According to (9), when the another vehicle stopped in front of the crosswalk is present on the adjacent lane in the same traveling direction as the scheduled traveling lane of the vehicle, the travel speed of the vehicle is restrained. As a result, it is possible to realize the control in consideration of safety provided in jumping out of the traffic participant from the shadow of the another vehicle to the scheduled traveling lane of the vehicle. Accordingly, it is possible to improve the traffic safety and contribute to the development of the sustainable transportation system.

(10) A control program that causes a computer that controls a vehicle to perform predetermined processing, the predetermined processing performed by the computer including:
recognizing a surrounding situation of the vehicle;
determining whether there is a crosswalk in a scheduled traveling lane of the vehicle that is traveling or starts traveling, based on a recognition result of the surrounding situation;
determining whether there is an adjacent lane that is adjacent to the scheduled traveling lane and has the same traveling direction as the scheduled traveling lane, based on the recognition result of the surrounding situation or map information prepared in advance;
determining, when it is determined that there is the crosswalk and there is the adjacent lane, whether there is another vehicle that is on the adjacent lane and is stopped in front of the crosswalk when viewed from the vehicle, based on the recognition result of the surrounding situation; and
performing restraint control for restraining a travel speed of the vehicle when it is determined that there is the another vehicle.

When there is the another vehicle stopped in front of the crosswalk, it is assumed that there is a traffic participant who is crossing or is going to cross the crosswalk. According to (10), when the another vehicle stopped in front of the crosswalk is present on the adjacent lane in the same traveling direction as the scheduled traveling lane of the vehicle, the travel speed of the vehicle is restrained. As a result, it is possible to realize the control in consideration of safety provided in jumping out of the traffic participant from the shadow of the another vehicle to the scheduled traveling lane of the vehicle. Accordingly, it is possible to improve the traffic safety and contribute to the development of the sustainable transportation system.

(11) A computer-readable storage medium storing the control program according to (10).

1. A vehicle control device that controls a vehicle, the vehicle control device comprising:
a recognition circuit configured to recognize a surrounding situation of the vehicle;
a first determination circuit configured to determine whether there is a crosswalk in a scheduled traveling lane of the vehicle that is traveling or starts traveling, based on a recognition result of the recognition circuit;
a second determination circuit configured to determine whether there is an adjacent lane that is adjacent to the scheduled traveling lane and has the same traveling direction as the scheduled traveling lane, based on the recognition result of the recognition circuit or map information prepared in advance;
a third determination circuit configured to, when the first determination circuit determines that there is the crosswalk and the second determination circuit determines that there is the adjacent lane, determine, based on the recognition result of the recognition circuit, whether there is another vehicle that is on the adjacent lane and is stopped in front of the crosswalk when viewed from the vehicle; and
a travel controller configured to perform restraint control for restraining a travel speed of the vehicle when the third determination circuit determines that there is the another vehicle.

2. The vehicle control device according to claim 1,
wherein the crosswalk is a crosswalk provided at a crossing point at which one road and another road cross each other, and
wherein the scheduled traveling lane and the adjacent lane are lanes included in the one road both in front of and behind the crossing point.

3. The vehicle control device according to claim 1,
wherein when the first determination circuit determines that there is the crosswalk and the second determination circuit determines that there is the adjacent lane, the third determination circuit determines whether there is the another vehicle that is on the adjacent lane, is stopped in front of the crosswalk when viewed from the vehicle, and is within a predetermined distance from the crosswalk, based on the recognition result of the recognition circuit.

4. The vehicle control device according to claim 1,
wherein when the first determination circuit determines that there is the crosswalk and the second determination circuit determines that there is the adjacent lane, the third determination circuit determines whether there is the another vehicle that is on the adjacent lane, is stopped in front of the crosswalk when viewed from the vehicle, and does not perform a predetermined out-of-vehicle notification, based on the recognition result of the recognition circuit.

5. The vehicle control device according to claim 4,
wherein the out-of-vehicle notification is a notification by a direction indicator, a hazard lamp, a stop display plate or a flame generating cylinder.

6. The vehicle control device according to claim 1,
wherein the vehicle control device further comprises a fourth determination circuit configured to determine whether a predetermined end condition for ending the restraint control is satisfied when the restraint control is being performed by the travel controller, and
wherein the travel controller ends the restraint control when the fourth determination circuit determines that the end condition is satisfied.

7. The vehicle control device according to claim 6,
wherein the fourth determination circuit determines that the end condition is satisfied when it is determined that there is no traffic participant in at least a predetermined range of the crosswalk based on the recognition result of the recognition circuit, and
wherein the predetermined range includes a portion of the crosswalk overlapping the scheduled traveling lane and a portion of the crosswalk overlapping the adjacent lane.

8. The vehicle control device according to claim 6,
wherein the fourth determination circuit determines that the end condition is satisfied when the vehicle passes through the crosswalk.

9. A control method performed by a computer that controls a vehicle, the control method comprising:
recognizing a surrounding situation of the vehicle;
determining whether there is a crosswalk in a scheduled traveling lane of the vehicle that is traveling or starts traveling, based on a recognition result of the surrounding situation;
determining whether there is an adjacent lane that is adjacent to the scheduled traveling lane and has the same traveling direction as the scheduled traveling lane, based on the recognition result of the surrounding situation or map information prepared in advance;
determining, when it is determined that there is the crosswalk and there is the adjacent lane, whether there is another vehicle that is on the adjacent lane and is stopped in front of the crosswalk when viewed from the vehicle, based on the recognition result of the surrounding situation; and
performing restraint control for restraining a travel speed of the vehicle when it is determined that there is the another vehicle.
